(19) United States
(12) Patent Application Publication
(10) Pub. No.: US 2015/0239487 A1
(43) Pub. Date: Aug. 27, 2015

(54) STEERING WHEEL COVER

(71) Applicant: Yuan-Yuan HUANG, Tainan City (TW)

(72) Inventor: Yuan-Yuan HUANG, Tainan City (TW)

(21) Appl. No.: 14/464,015

(22) Filed: Aug. 20, 2014

(30) Foreign Application Priority Data
Feb. 24, 2014 (TW) 103203152

(51) Int. Cl. B62D 1/06

(52) U.S. Cl. CPC B62D 1/06

(57) ABSTRACT

A steering wheel cover includes an annular resilient body having a C-shaped cross-section, defining an axis, and adapted for gripping onto an annular portion of a steering wheel. The resilient body includes opposite annular end portions and an annular connecting portion. The end portions are spaced apart from each other along the axis. The connecting portion interconnects radial outer ends of the end portions, and cooperates with the end portions to define a receiving space that is adapted to receive the annular portion of the steering wheel. At least one of the end portions and the connecting portion is formed with multiple angularly spaced-apart gaps that communicate the receiving space with the external environment.

### CROSS-REFERENCE TO RELATED APPLICATION

This application claims priority of Taiwanese Patent Application No. 103203152, filed on Feb. 24, 2014.

### BACKGROUND OF THE INVENTION

1. Field of the Invention

The invention relates to a cover, more particularly to a steering wheel cover.

2. Description of the Related Art

Referring to FIG. 1, in order to improve gripping comfort of a steering wheel (not shown), a conventional steering wheel cover 100 is generally fitted onto a ring portion of the steering wheel. The conventional steering wheel cover 100 includes a rubber inner body 101, and an outer body 103 that has a superficial, specifically textured design and that tightly grips onto an outer surface of the inner body 101. During installation, the conventional steering wheel cover 100 is stretched open from an opening 102, and is then fitted onto the ring portion of the steering wheel.

In order to prevent movement of the conventional steering wheel cover 100 relative to the steering wheel for safety purposes, the inner body 101 is designed to be roughly of the same size as the ring portion of the steering wheel, and the inner body 101 is usually made of a hard rubber material that is not easily deformable, thereby allowing the conventional steering wheel cover 100 to fixedly grip onto the steering wheel. However, this design is inconvenient due to the significant amount of effort that must be exerted to stretch the conventional steering wheel cover 100. In addition, since the size of the conventional steering wheel cover 100 needs to be roughly the same as that of the ring portion of the steering wheel, different sized steering wheel covers must be made to fit correspondingly different sized steering wheels.

### SUMMARY OF THE INVENTION

Therefore, the object of the present invention is to provide a steering wheel cover that can eliminate at least one of the aforesaid drawbacks of the prior art.

According to the present invention, there is provided a steering wheel cover including an annular resilient body that has a C-shaped cross-section, that defines an axis, and that is adapted for gripping onto an annular portion of a steering wheel. The resilient body includes opposite annular end portions and an annular connecting portion. The end portions are spaced apart from each other along the axis. The connecting portion interconnects radial outer ends of the end portions, and cooperates with the end portions to define a receiving space that is adapted to receive the annular portion of the steering wheel. At least one of the end portions and the connecting portion is formed with a plurality of angularly spaced-apart gaps that communicate the receiving space with the external environment.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of the conventional steering wheel cover;

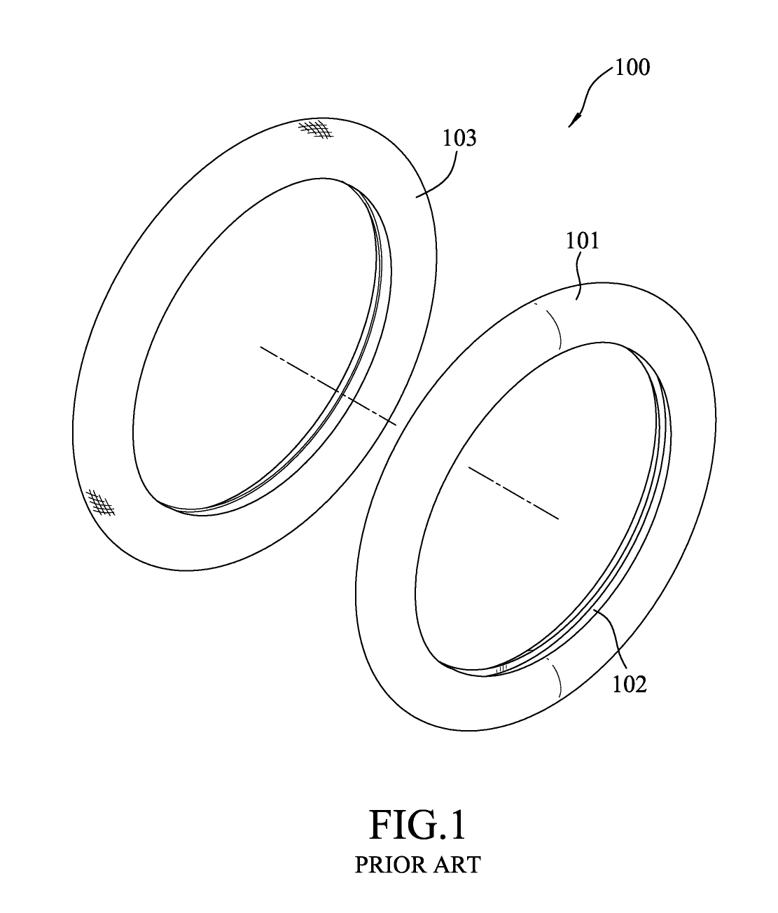

FIG. 2 is an assembled perspective view of a first preferred embodiment of a steering wheel cover according to the present invention;

FIG. 3 is an exploded perspective view of the first preferred embodiment;

FIG. 4 is a sectional view of the first preferred embodiment taken along line IV-IV of FIG. 2;

FIG. 5 is an enlarged fragmentary perspective view of a resilient body of the first preferred embodiment;

FIG. 6 is a front view of a resilient body according to a modified first preferred embodiment;

FIG. 7 is an enlarged fragmentary perspective view of a resilient body of a second preferred embodiment of the steering wheel cover according to the present invention;

FIG. 8 is a sectional view of the second preferred embodiment; and

FIG. 9 is an enlarged fragmentary perspective view of a resilient body of a third preferred embodiment of the steering wheel cover according to the present invention.

### DETAILED DESCRIPTION OF THE PREFERRED EMBODIMENTS

Before the present invention is described in greater detail, it should be noted that like elements are denoted by the same reference numerals throughout the disclosure.

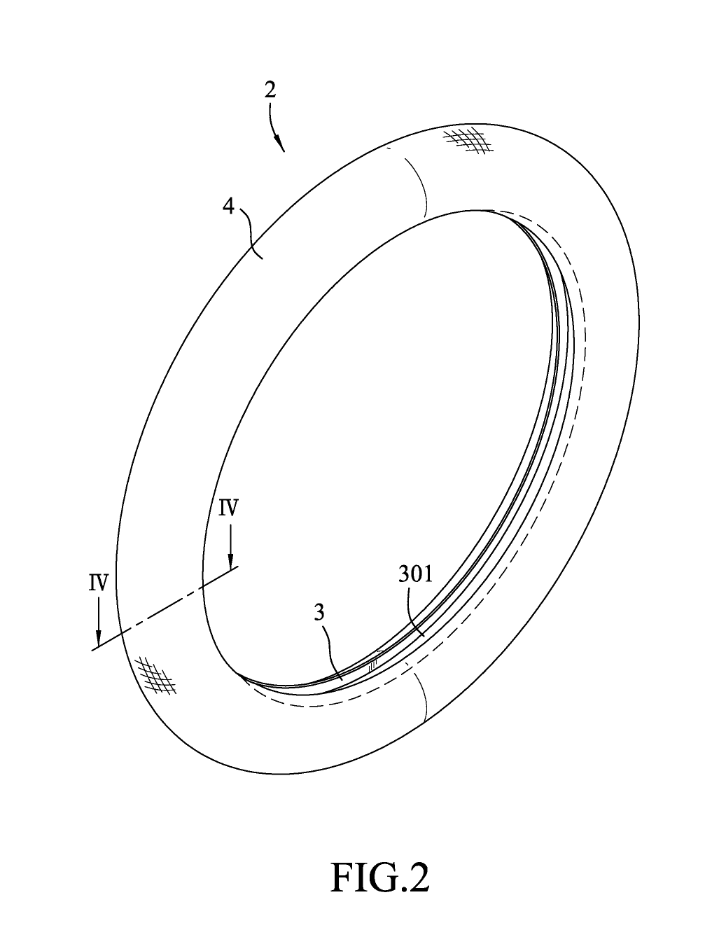

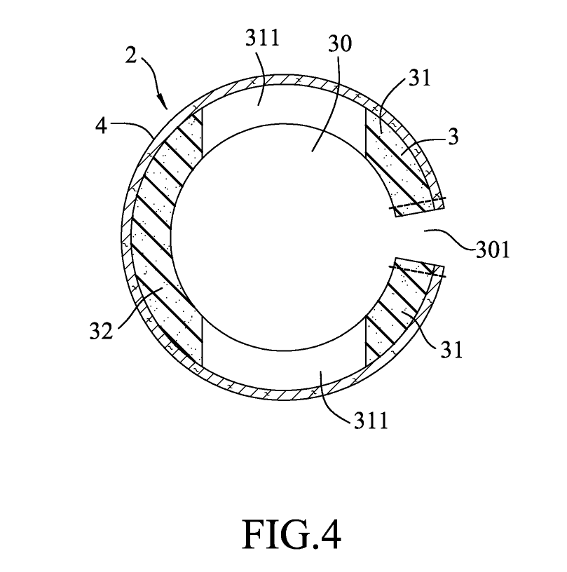

Referring to FIGS. 2 to 4, the first preferred embodiment of a steering wheel cover 2 according to the present invention includes an annular resilient body 3 and an annular outer body 4.

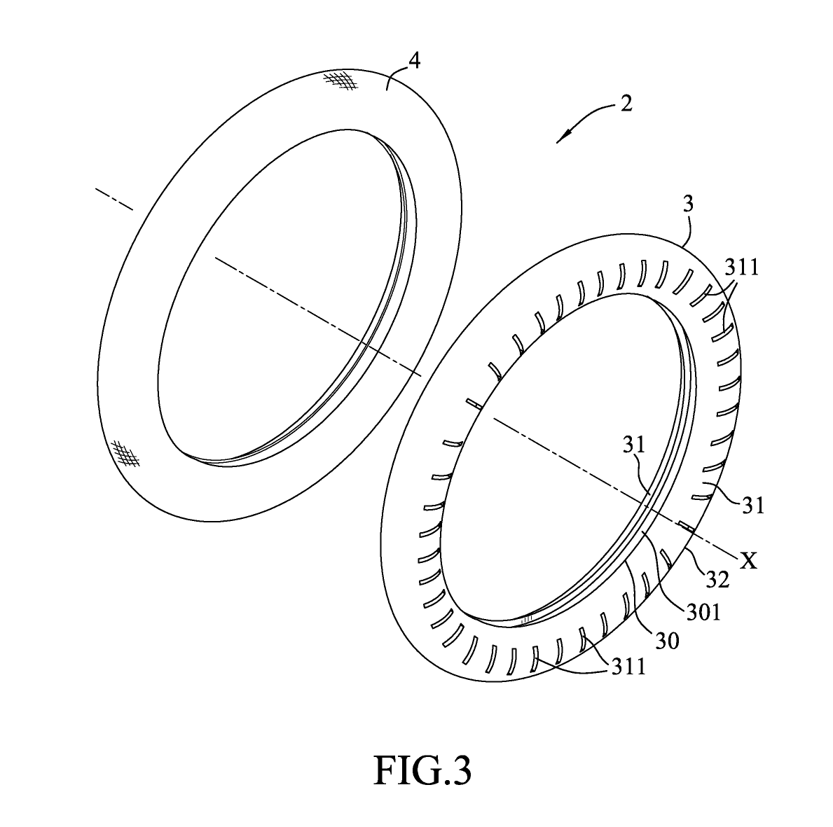

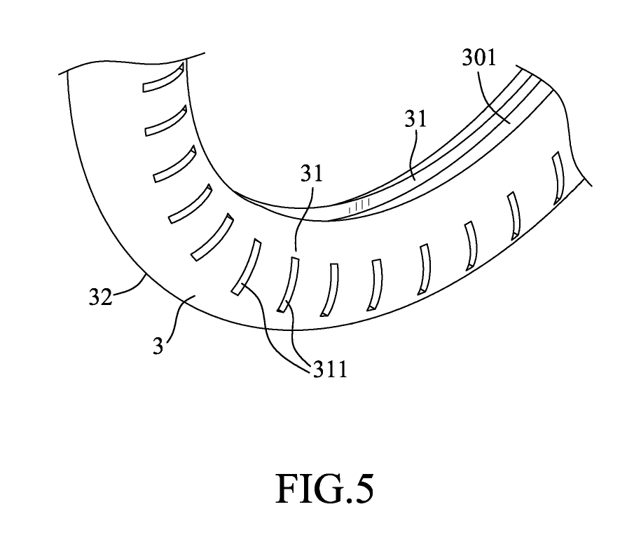

Referring to FIGS. 3 to 5, the resilient body 3 is made of an elastically deformable material, such as rubber, has a C-shaped cross-section, defines an axis (X), and is adapted for gripping onto an annular portion of a steering wheel. The resilient body 3 includes opposite annular end portions 31 and an annular connecting portion 32. The end portions 31 are spaced apart from each other along the axis (X). Radial inner ends of the end portions 31 cooperatively define an opening 301 therebetween. The connecting portion 32 interconnects radial outer ends of the end portions 31, and cooperates with the end portions 31 to define a receiving space 30 that is in spatial communication with the opening 301 and that is adapted to receive the annular portion of the steering wheel through the opening 301.

Each of the end portions 31 is formed with a plurality of angularly spaced-apart gaps 311 that communicate the receiving space 30 with the external environment. In this embodiment, the end portions 31 are symmetrical to each other along the axis (X) and each of the gaps 311 is formed as a slot extending substantially radially with respect to the axis. In other embodiments of this invention, each of the gaps 311 may be circular, diamond or any geometric shape, and is not limited to what is disclosed herein.

In this embodiment, the outer body 4 has a C-shaped cross-section, and is used for gripping onto an annular outer portion of the resilient body 3 (i.e., outer surfaces of the end portions 31 and the connecting portion 32). Radial inner ends of the outer body 4 are fixedly and respectively sewed to the radial inner ends of the end portions 31 of the resilient body 3 for locking the outer body 4 onto the resilient body 3, which allows the outer body 4 to deform along with the resilient body 3. Since the outer body 4 can be made of different materials (such as cloth, plastic films, among others) and may have varying structures for coupling with the resilient body 3 in different manners as known in the art, details of the same will be omitted herein for the sake of brevity.

During manufacture of the steering wheel cover 2, the presence of the gaps 311 facilitates deformation of the end portions 31, so that the resilient body 3 is easy to be expanded and folded when the outer body 4 and the resilient body 3 are sewn together.

During installation of the steering wheel cover 2 on the steering wheel, due to the provision of the gaps 311 formed in the end portions 31, the steering wheel cover 2 can be easily and resiliently stretched to enlarge the opening 301, thereby facilitating the fitting of the steering wheel cover 2 on the annular portion of the steering wheel.

Furthermore, since the gaps 311 are formed in the end portions 31, the resilient body 3 can be easily expanded to receive different sized steering wheels, thereby enhancing flexibility of application of the steering wheel cover 2.

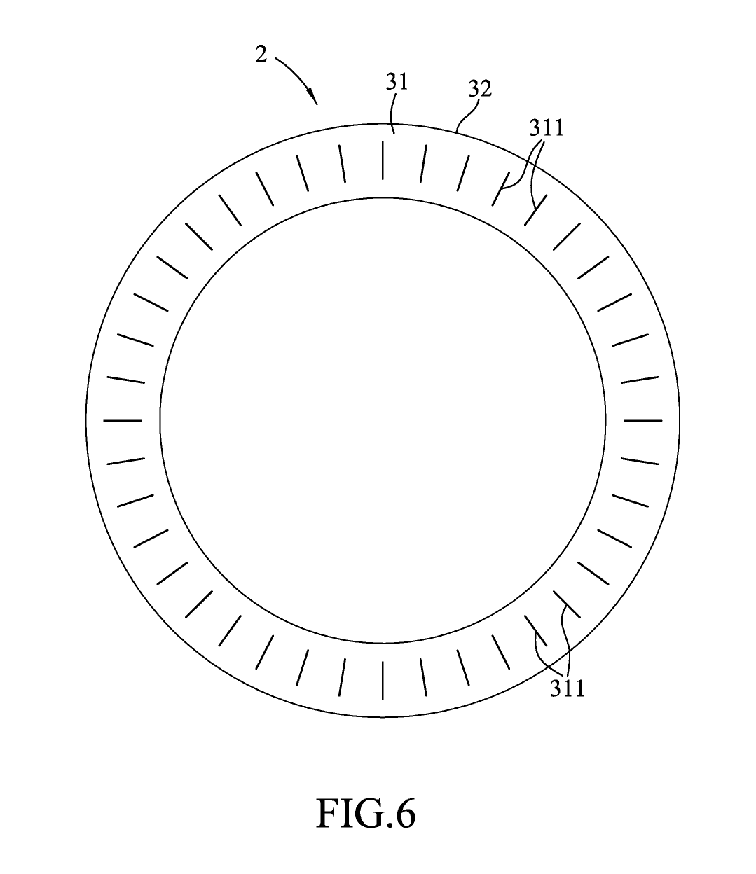

Referring to FIG. 6, in a modification of this embodiment, the gaps 311 may be formed as substantially radially-extending slits. Prior to expansion of the steering wheel cover 2, the slit-shaped gaps 311 are not visible, and only long thin lines can be seen on the surface of the end portions 31 (only one can be seen in FIG. 6). However, as the steering wheel cover 2 is being expanded (stretched outward), the gaps 311 open and facilitate deformation of the steering wheel cover 2.

On the other hand, the gaps 311 may be formed in only one of the end portions 31 of the resilient body 3, which also achieves the goal of facilitating deformation of the steering wheel cover 2.

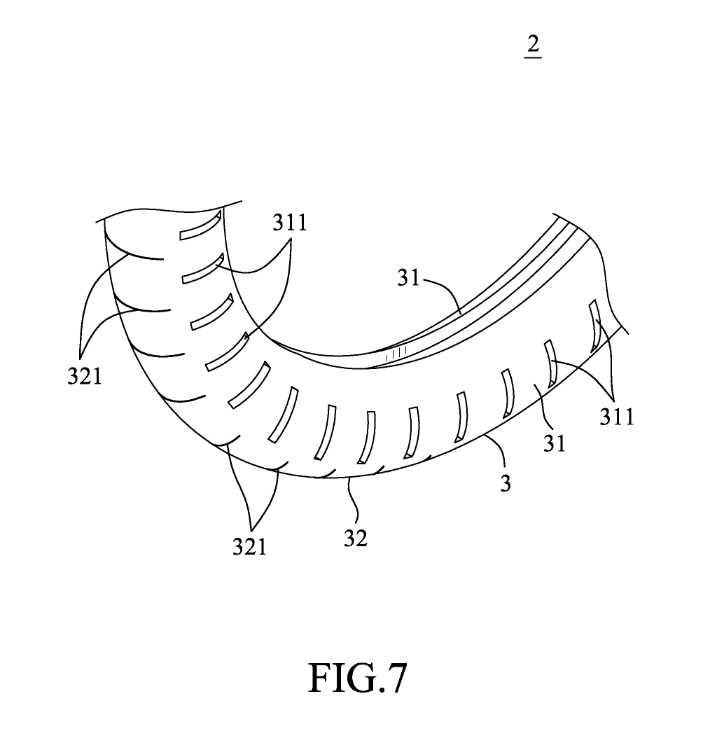

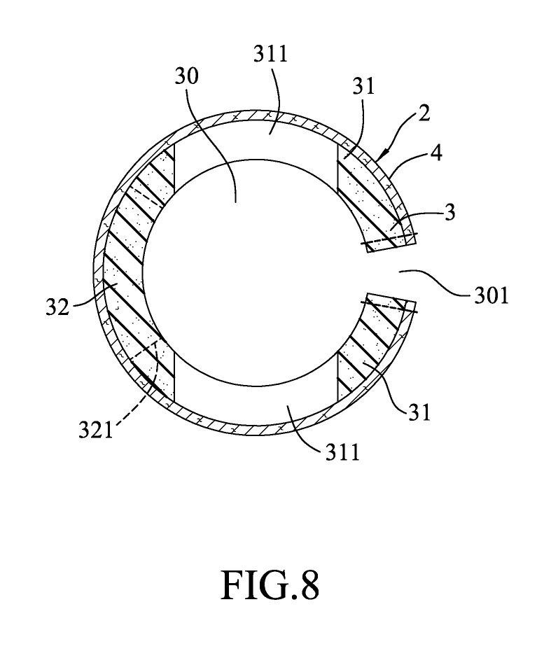

Referring to FIGS. 7 and 8, the second preferred embodiment of a steering wheel cover 2 according to the present invention is similar to the first preferred embodiment in structure and differs in the structural design of the connecting portion 32.

In this embodiment, the connecting portion 32 is formed with a plurality of gaps 321 that extend along substantially in the direction of the axis (X) (as shown in FIG. 3). The gaps 321 are staggered relative to the gaps 311. In this embodiment, the gaps 321 are formed as slits. Similar to the previous embodiment, the slit-shaped gaps 321 are not visible prior to expansion of the resilient body 3, only long thin lines can be seen on the surface of the connecting portion 32. However, during expansion of the steering wheel cover 2, the gaps 321 open and facilitate deformation of the steering wheel cover 2.

With the presence of the gaps 311, 321 in the resilient body 3, the resistance against deformation of the resilient body 3 is further diminished and the flexibility of the steering wheel cover 2 is further enhanced.

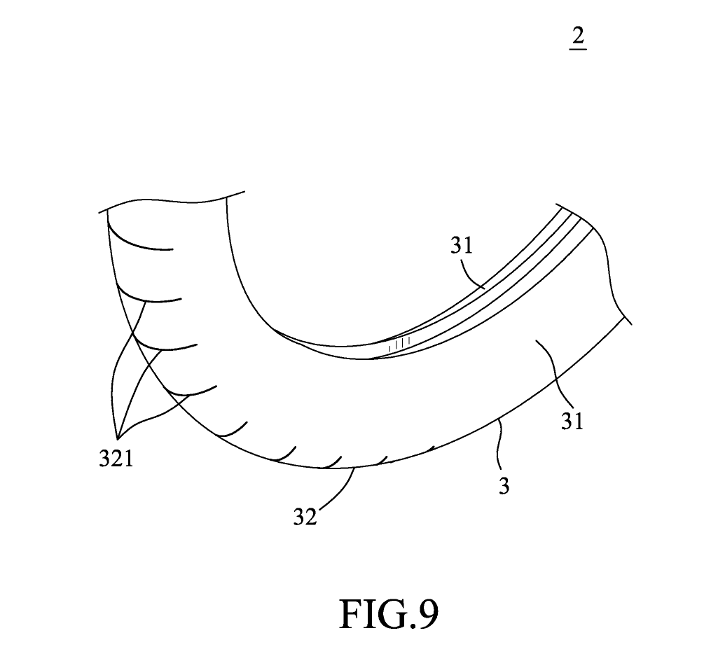

With reference to FIG. 9, in the third preferred embodiment of the steering wheel cover 2 which has a similar structure to that of the second preferred embodiment, the gaps 311 (see FIG. 7) in the end portions 31 may be removed, such that the resilient body 3 is only formed with the gaps 321 in the connecting portion 32. This structural design achieves the same goal of the previously mentioned embodiments.

In sum, through the design of the resilient body 3 where the gaps 311, 321 are formed in at least one of the end portions 31 and the connecting portion 32, the deformation of the resilient body 3 for expansion or folding can be facilitated, and the coupling between the outer body 4 and the resilient body 3 can be simplified. In addition, the same steering wheel cover 2 can be fitted onto steering wheels of different sizes.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A steering wheel cover comprising:
an annular resilient body having a C-shaped cross-section, defining an axis, and adapted for gripping onto an annular portion of a steering wheel, said resilient body including
opposite annular end portions that are spaced apart from each other along the axis, and
an annular connecting portion that interconnects radial outer ends of said end portions, and that cooperates with said end portions to define a receiving space which is adapted to receive the annular portion of the steering wheel,
at least one of said end portions and said connecting portion being formed with a plurality of angularly spaced-apart gaps that communicate said receiving space with the external environment.

2. The steering wheel cover as claimed in claim 1, wherein said gaps are formed in one of said end portions of said resilient body.

3. The steering wheel cover as claimed in claim 2, wherein each of said gaps is formed as a slot extending substantially radially with respect to the axis.

4. The steering wheel cover as claimed in claim 1, wherein said gaps are formed in said end portions of said resilient body.

5. The steering wheel cover as claimed in claim 4, wherein said end portions are symmetrical to each other along the axis.

6. The steering wheel cover as claimed in claim 4, wherein each of said gaps is formed as a slot extending substantially radially with respect to the axis.

7. The steering wheel cover as claimed in claim 1, wherein said gaps are formed in said connecting portion of said resilient body.

8. The steering wheel cover as claimed in claim 7, wherein each of said gaps extends substantially parallel to the axis.

9. The steering wheel cover as claimed in claim 8, wherein each of said gaps is formed as a slit.

10. The steering wheel cover as claimed in claim 2, wherein said gaps are further formed in said connecting portion of said resilient body.

11. The steering wheel cover as claimed in claim 10, wherein each of said gaps of said one of said end portions is formed as a slot extending substantially radially.

12. The steering wheel cover as claimed in claim 10, wherein each of said gaps of said connecting portion extends parallel to the axis.

13. The steering wheel cover as claimed in claim 12, wherein each of said gaps of said connecting portion is formed as a slit.

14. The steering wheel cover as claimed in claim 1, wherein said gaps are formed in said end portions and said connecting portion of said resilient body.

15. The steering wheel cover as claimed in claim 14, wherein each of said gaps of each of said end portions is formed as a slot extending substantially radially with respect to the axis.

16. The steering wheel cover as claimed in claim 14, wherein each of said gaps of said connecting portion extends substantially parallel to the axis.

17. The steering wheel cover as claimed in claim 16, wherein each of said gaps of said connecting portion is formed as a slit.

18. The steering wheel cover as claimed in claim 1, further comprising an annular outer body for gripping onto an outer surface of said resilient body.
